(19) United States
(12) Patent Application Publication
(10) Pub. No.: US 2016/0129758 A1
(43) Pub. Date: May 12, 2016

(54) GRATING FOR HOMOGENIZING A FLOW OF AIR AND CORRESPONDING HEATER UNIT

(71) Applicant: Valeo Systemes Thermiques, Le Mesnil Saint Denis (FR)

(72) Inventors: Amanda Martinell, Neauphle-Le-Château (FR); Fabrice Ailloud, Guyancourt (FR); Michel Grellier, Fresnes (FR); Claire Sicot, Guyancourt (FR)

(73) Assignee: Valeo Systemes Thermiques, Le Mesnil Saint Denis (FR)

(21) Appl. No.: 14/894,581

(22) PCT Filed: May 28, 2014
(86) PCT No.: PCT/EP2014/061132

§ 371 Date: Nov. 30, 2015

(30) Foreign Application Priority Data
May 30, 2013 (FR) 1354963

(51) Int. Cl. B60H 1/22

(52) U.S. Cl. CPC B60H 1/2218; B60H 1/2225; B60H 2001/2268

(57) ABSTRACT

The invention concerns a grid (14) for homogenising an air stream for a heating apparatus for a motor vehicle comprising an electric heating device, said grid comprising: —a first area (Z1) having at least one first opening (29) intended to be arranged upstream from at least one heat sink in the direction of flow of said air stream, said at least one heat sink being arranged on one side of said heating device, and—a second area (Z2) separate from the first area (Z1) and having a plurality of second openings (31) intended to be arranged upstream from at least one heating element of said heating device in the direction of flow of said air steam. The invention also concern a heating apparatus comprising: —an electrical heating device comprising: at least one heating element, an electronic control unit, and at least one heat sink arranged on one side of said heating device, and—such a grid (14) arranged upstream from said heating device in the direction of flow of said air stream.

The present invention relates to a grating for homogenizing a flow of air for a heater unit for a motor vehicle interior that allows control over the temperature of the flow of air in one or more zone(s) of the interior of a motor vehicle.

A motor vehicle is commonly fitted with a heater unit intended to regulate the aerothermal parameters of the air distributed to the vehicle interior, particularly the temperature of a flow of air delivered by the unit to the inside of the vehicle interior.

In general terms, the unit comprises a housing delimited by separations through one which openings are formed, these openings including at least one air inlet and at least one air distribution outlet.

In the known way, the housing generally houses a motor/fan unit also known as a blower for circulating the flow of air from the air inlet to the air distribution outlet.

The housing also houses heat treatment means notably for heating up the flow of air before it is distributed to the inside of the vehicle interior through the air distribution outlet.

Usually in a motor vehicle with an internal combustion engine, the air intended for heating the interior and for demisting and deicing is heated up by passing a flow of air through a heat exchanger, more specifically by an exchange of heat between the flow of air and a liquid, generally the engine coolant.

In the case of an electric vehicle propelled by an electric motor powered by an onboard voltage source, namely batteries, the heat treatment means generally comprise an electric device which is intended to heat up the air that passes through it.

This electric heating device notably comprises heating elements, such as resistive elements, powered by the batteries and positioned in such a way as to be exposed directly to the air passing through the electric heating device.

According to one known solution, the heating device comprises resistive elements, for example positive temperature coefficient (PTC) elements, such as PTC stones. These are elements the resistance of which varies very greatly as a function of temperature. More specifically, the resistance of PTC resistive elements increases very rapidly above a predetermined temperature threshold.

An electric connector allows the electric power needed for powering the electric heating device, for example for powering the resistive elements, to be carried. This electric connector may be connected to a voltage source carried on board of the vehicle.

Furthermore, these resistive elements are controlled by an electronic control unit. The electronic control unit is, for example, borne by the electric connector.

However, this electronic control unit for controlling the PTC heating device heats up a great deal and, as a safety precaution, the supply of electrical power is cut off if a given threshold temperature is exceeded.

In order to avoid this thermal tripping which is achieved by cutting the supply of power, the electronic control unit therefore needs to be cooled.

To do this, it is possible to provide heat sinks in thermal contact with the connector bearing the electronic control unit. In order to avoid thermal tripping, more air can be sent to the heat sinks.

However, when the heat sinks are arranged on one and the same side of the heating device, more air is sent to this side, thus causing a thermal imbalance between the air outlets on the two sides of the heating device.

However, constraints concerned with comfort within the vehicle dictate that there must be a small difference in temperature between the air outlets of the PTC heating device on the side that has the heat sinks and on the other side that does not have the heat sinks. Notably a tolerance of the order of 5° C. of temperature difference between the outlets of the heating device is desired.

In order to do this, it is necessary to homogenize the flow of air that is to pass through the electric heating device.

Heating and/or air conditioning units that further comprise an evaporator for the air conditioning function so that the flow of air bound for the vehicle interior can be cooled or for example so that the flow of air can be dehumidified before it passes through the heating device are known. In such cases, the evaporator is positioned upstream of the heating device and homogenizes the way in which the flow of air flows.

However, in the case of a heater unit that has no evaporator upstream of the heating device, the function of homogenizing the flow of air upstream of the heating device is no longer performed by an evaporator.

Gratings for homogenizing the way in which a flow of air flows and which are positioned upstream of a heat exchanger in the absence of an evaporator are also known.

However, these known homogenization gratings are not suited to applications with a high voltage PTC heating device requiring the cooling of the heat sinks able to dissipate the heat generated by the electronic control unit.

It is therefore an objective of the invention to at least partially overcome these disadvantages of the prior art by proposing a solution for distributing the flow of air that is to pass through the PTC heating device that allows the PTC heating device to be swept homogeneously by the flow of air while at the same time preventing thermal tripping if the heat sinks exceed the temperature threshold.

The present invention affords a solution using a grating for homogenizing a flow of air for a heater unit for a motor vehicle comprising an electric heating device for heating the flow of air,

characterized in that it comprises:
a first zone having at least one first opening intended to be positioned upstream of at least one heat sink in the direction in which said flow of air flows, the heat sink being arranged on one side of the electric heating device adjacent to an electronic control unit of the electric heating device so as to be able to dissipate the heat generated by the electronic control unit, and
a second zone distinct from the first zone and having a plurality of second openings which are intended to be positioned upstream of at least one heating element of the electric heating device in the direction in which said flow of air flows.

The first opening allows part of the stream of air to be directed toward the heat sink or sinks in such a way that it/they can be cooled and the electronic control unit is also cooled whereas the plurality of second openings contribute to distributing a uniform flow of air to the rest of the heating device, when the homogenization grating is positioned upstream of this electric heating device in a corresponding heater unit.

The first opening is dimensioned not to generate a great difference in temperature between the air outlet on the side of the electric heating device in the region of the heat sink or sinks and the air outlet of the electric heating device on the other side.

According to one aspect of the invention, said second openings respectively have a cross section for the passage of air that is smaller than the cross section for the passage of air of said at least one first opening.

According to one preferred embodiment, the homogenization grating has at least one solid part positioned between said at least one first opening and the plurality of second openings. This solid part adjacent to the first opening makes it possible to comply with a temperature difference of the order of +/−5° C. between the air outlets of the electric heating device when the homogenization grating is positioned upstream of this electric heating device in a corresponding heater unit.

Said homogenization grating may further comprise one or more of the following features, considered separately or in combination:
the homogenization grating is of substantially parallelepipedal overall shape,
said at least one solid part extends over the entire height of the homogenization grating,
said at least one solid part extends over a width that is in a ratio of the order of one to three with the width of the first opening,
the second openings have heterogeneous air-passage cross sections, in order better to distribute the flow of air uniformly according to the speed and flow conditions of the flow of air,
the homogenization grating is made of plastic.

These features of the homogenization grating make it possible to improve the homogeneous distribution of the flow of air to the heating device while at the same time ensuring that the electronic control unit is cooled, and doing so without generating a temperature difference in excess of +/−5° C. at the outlets of the electric heating device during operation.

In addition, the arrangement of the openings is chosen to correspond to the structure of the associated electric heating device.

The invention also relates to a heater unit for a motor vehicle comprising an electric heating device for heating a flow of air bound for the interior of said vehicle, the electric heating device being intended to have the flow of air that is to be heated up passing through it and comprising:
at least one heating element,
an electronic control unit configured to control said at least one heating element, and
at least one heat sink arranged on one side of the electric heating device adjacent to the electronic control unit so as to be able to dissipate the heat generated by the electronic control unit,

characterized in that the heater unit further comprises a homogenization grating as defined hereinabove:
positioned in the heater unit upstream of the electric heating device in the direction in which said flow of air flows, and
comprising:
   a first zone having at least one first opening positioned upstream of said at least one heat sink, and
   a second zone distinct from the first zone and having a plurality of second openings positioned upstream of said at least one heating element in the direction in which said flow of air flows.

With such a homogenization grating, the heater unit is improved. Specifically, the heat sinks can be cooled via the first opening so that tripping in which the electric supply is cut to afford thermal protection can be avoided. Furthermore, the heater unit is able to meet manufacturer requirements in terms of comfortable vehicle interior temperatures and in terms of temperature difference according to the air outlet side of the electric heating device.

According to one preferred embodiment, said at least one heating element is a positive temperature coefficient resistive element. The electronic control unit of such an electric heating device with positive temperature coefficient resistive elements heats up a great deal and requires a good level of cooling performed by the first opening upstream of the heat sink or sinks dissipating the heat generated by the electronic control unit.

Said heater unit may further comprise one or more of the following features, considered separately or in combination:
the homogenization grating is substantially parallelepipedal and said at least one first opening of the homogenization grating extends over a height of the order of 50% to 120% of the height of said at least one heat sink of the electric heating device,
the homogenization grating is substantially parallelepipedal and said at least one first opening extends over a width substantially equal to the width of said at least one heat sink of the electric heating device,
the electric heating device comprises a connector bearing the electronic control unit made of a thermally conducting metallic material and in which said at least one heat sink is made as one with the connector,
said heater unit comprises a plurality of heat sinks defining a substantially comb-like overall shape,
the electric heating device comprises at least one heat exchange fin positioned in thermal contact with said at least one heating element and configured to have passing through it the flow of air that passes through the electric heating device and to transmit the heat of said at least one heating element to said flow of air,
said second openings respectively have a cross section for the passage of air that is smaller than the cross section for the passage of air of said at least one first opening,
the homogenization grating has at least one solid part positioned between said at least one first opening and the plurality of second openings,
the homogenization grating has a substantially parallelepipedal overall shape,
said at least one solid part extends over the entire height of the homogenization grating,
said at least one solid part extends over a width that is in a ratio of the order of one to three with the width of the first opening,
the second openings have heterogeneous air-passage cross sections,
the homogenization grating is made of plastic.

Other features and advantages of the invention will become more clearly apparent from reading the following description, given by way of nonlimiting illustrative example, and from studying the attached drawings among which:

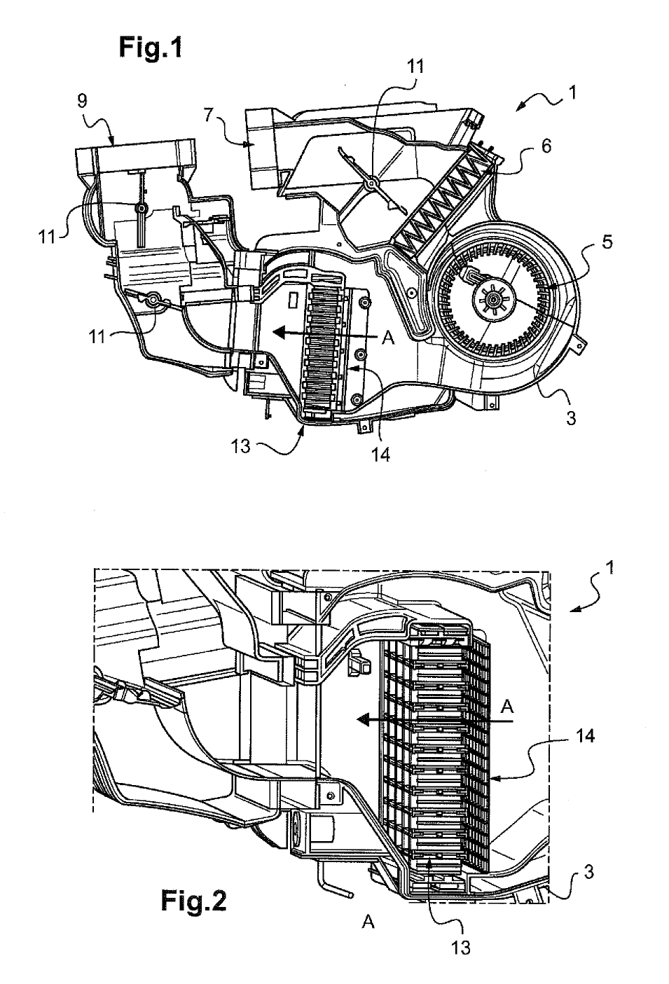

FIG. 1 is a schematic cross section of a heater unit according to the invention,

FIG. 2 is an enlarged view of part of the heater unit of FIG. 1,

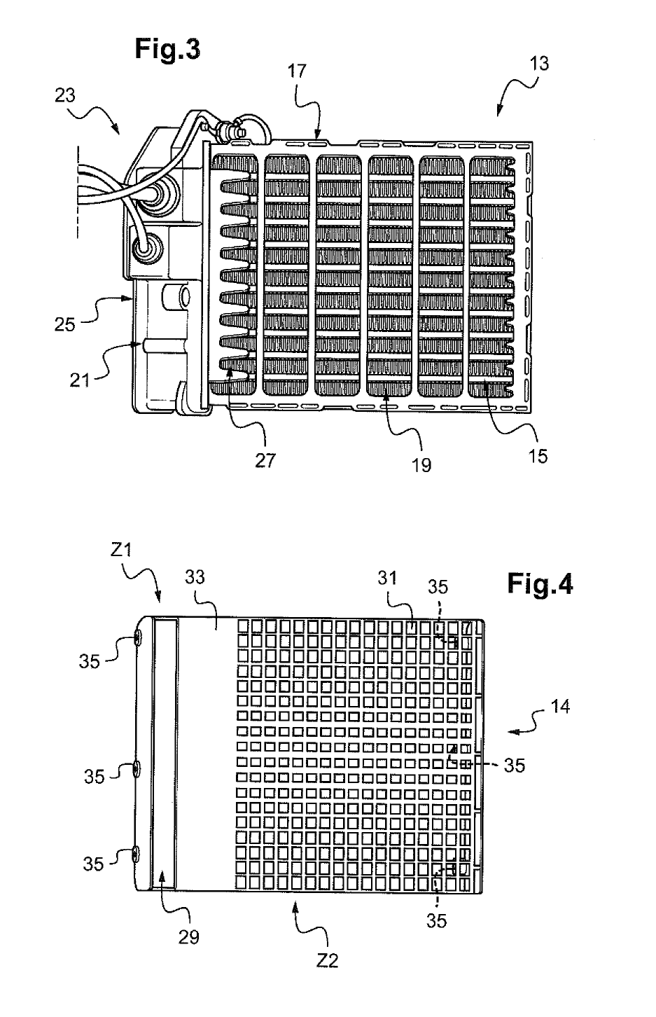

FIG. 3 depicts an electric heating device of the heater unit of FIG. 1, and

FIG. 4 is a schematic depiction of a homogenization grating for homogenizing the flow of air that is to pass through the electric heating device of FIG. 3.

In these figures, elements that are identical bear the same references.

FIG. 1 depicts a cross section of a heater unit 1 intended to be fitted to a motor vehicle in order to regulate the aerothermal parameters of the flow of air distributed to one or more zones of the vehicle interior.

The heater unit 1 comprises a housing 3 delimiting an internal volume defining a passage for the circulation of a flow of air.

The heater unit 1 comprises a motor-fan unit also referred to as a blower 5 for introducing air into the housing 3 of the heater unit 1. An air filter 6 may be provided upstream of the blower 5 in the direction in which the flow of air flows through the housing 3.

The housing 3 comprises at least one intake 7 for admitting a flow of outside air from outside of the vehicle so it can circulate through the internal volume delimited by the housing and/or a flow of recirculated air from the vehicle interior and being circulated once again through the internal volume delimited by the housing 3. The heater unit 1 can just as well be supplied with the flow of outside air or the flow of recirculated air as it can with a mixture of these two flows of outside and recirculated air.

The housing 3 also comprises at least one outlet 9 delivering the flow of air to one or more zones of the vehicle interior.

One or more mixing flaps 11 may also be arranged in the housing 3 to distribute or mix the flow of air.

The heater unit 1 further comprises means for heat treating the flow of air introduced into the heater unit 1.

According to the embodiment described, the heater unit 1 comprises:
an electric heating device 13, otherwise known as an electric heater, best visible in FIGS. 2 and 3, for heating up the flow of air, and
a homogenization grating 14, best visible in FIGS. 2 and 4, positioned upstream of the electric heating device 13 in the direction in which the flow of air flows through the heater unit 1 as illustrated by FIG. 1.

Referring once again to FIGS. 1 and 2, the electric heating device 13 is arranged in the housing of the heater unit 1 so that the flow of air that is to be heated up passes through it.

The electric heating device 13 is positioned transversely across the stream of air of the heater unit 1. The flow of air that is to be heated up passes through the electric heating device 13 in a direction substantially perpendicular to the overall plane defined by the electric heating device 13, as illustrated schematically by the arrow A. The electric heating device 13 therefore has two opposite air inlet and outlet faces, in the direction in which the flow of air that is to be heated up flows.

The electric heating device 13 is able to convert the electrical energy drawn for example from the vehicle into thermal energy given up to the air passing through the heater unit 1.

With reference to FIG. 3, the electric heating device 13 may comprise at least one heating element 15.

More specifically, a heating element 15 may be a resistive element of the positive temperature coefficient (PTC) type. The resistive elements 15 are, for example, produced in the form of PTC stones. The resistive element 15 may be of substantially parallelepipedal shape.

The electric heating device 13 may further comprise a frame 17, for example made of plastic, inside which the heating elements 15 are positioned.

The heating elements 15 are positioned in the frame 17 of the electric heating device 13 in such a way as to be exposed directly to the flow of air passing through the electric heating device 13. More specifically, in the example described, the heating elements 15 housed in the frame 17 of the electric heating device 13 extend substantially at right angles to the direction of the flow of air passing through the electric heating device 13.

The electric heating device 13 may comprise also at least one heat exchange fin 19 formed for example of a pleated or corrugated metal strip pressing against the heating elements 15, such as PTC stones.

According to the embodiment illustrated in FIG. 3, the electric heating device 13 comprises a plurality of heat exchange fins 19 positioned in alternation with the heating elements 15 and in such a way that each heating element 15 is flanked by two heat exchange fins 19.

The function of the heat exchange fins 19 produced by the corrugated strips 19 in the example illustrated in FIG. 3 is to exchange, with the flow of air passing through the electric heating device 13, the heat produced by the heating elements 15, for example resistive PTC elements, so as to heat the flow of air passing across the heat exchange fins 19. The heat exchange fins 19 allow the heat of the resistive elements 15 to be transmitted to the flow of air that is to be heated up which is passing through the electric heating device 13.

To do that, the heat sinks 19 are made of a thermally conducting metallic material and are positioned in thermal contact with the heating elements 15.

Moreover, the heating elements 15 are electrically powered.

The heating device 3 may for this purpose comprise a connector 21 connected on the one hand to a source of electric power, for example coming from the vehicle and, on the other hand, to electrically conducting terminations (not visible) of the heating elements 15. In the example illustrated, the connector 21 may be connected to high-voltage and low-voltage cables 23 of the vehicle.

The connector 21 therefore allows the source of electrical power coming, for example, from the vehicle, to be electrically connected to the heating elements 15 of the electric heating device 13.

The electric heating device 13 further comprises an electronic control unit 25 for controlling the heating elements 15.

In order to connect this electronic control unit 25 to the heating elements 15, the electric heating device 13 comprises for example a connector, in this example the connector 21. The connector 21 may bear the electronic control unit 25.

Thus, the connector 21 forms a means of connection both to the source of electric power and to the electronic control unit.

The electric heating device 13 also comprises at least one heat sink 27 that allows the electronic control unit 25 to be cooled, thus preventing thermal tripping or malfunctioning of the electric heating device 13 as a result of the supply of power being cut off if the temperature becomes too high and exceeds a predefined threshold.

According to the embodiment illustrated, the electric heating device 13 comprises a plurality of heat sinks 27.

To that end, the heat sinks 27 are made of a thermally conducting, for example metallic, material and are positioned in such a way as to be able to dissipate the heat generated by the electronic control unit 25.

More specifically in the example illustrated, the heat sinks 27 are made as one with the connector 21 bearing the electronic control unit 25. The connector 21 in this example is made of a thermally conducting metallic material.

In addition, the heat sinks 27 could be not uniformly distributed over the surface for exchange of heat of the electric heating device 13 with the flow of air passing over it.

Indeed, according to the embodiment described, the heat sinks 27 are positioned on one and the same side of the electric heating device 13, namely the side of the electric heating device 13 connected to the connector 21, and are therefore adjacent to the electronic control unit 25.

Moreover, the heat sinks 27 together define for example a substantially comb-like overall shape.

Referring once again to FIG. 2, the homogenization grating 14 is positioned upstream of the electric heating device 13 in the direction in which the flow of air bound for the vehicle interior and that is to be heated up flows.

More specifically, the homogenization grating 14 is positioned in the housing 3 of the heater unit 1 across the entire air passage cross section upstream of the electric heating device 13 so as to force the flow of air bound for the vehicle interior to pass completely through the homogenization grating 14.

The homogenization grating 14 is configured to:
on the one hand, distribute a minimum flow of air for sweeping over and cooling the heat sinks 27, and
on the other hand guarantee thermal equilibrium at the air outlets of the electric heating device 13 in order to comply with constraints of comfort and with the specifications of the manufacturers, notably a temperature difference of the order of +/−5° C.

With reference to FIG. 4, the homogenization grating 14 is of substantially parallelepipedal shape.

The homogenization grating 14 comprises a first zone Z1 having at least one first opening 29 intended to be positioned facing the heat sinks 27 of the electric heating device 13.

According to a preferred embodiment, the first zone Z1 of the homogenization grating 14 has a single first opening 29 intended to be positioned facing the heat sinks 27 of the electric heating device 13.

The first opening 29 may extend over a height of the order of 50% to 120% of the height of the heat sinks 27. The first opening 29 advantageously extends over a width corresponding substantially to the width of the heat sinks 27 of the heating device.

The homogenization grating 14 also comprises a second zone Z2 distinct from the first zone Z1. This second zone Z2 has a plurality of second openings 31 which are intended to be upstream of the heating elements 15 in the direction in which the flow of air to be heated up passing through the electric heating device 13 flows when the homogenization grating 14 is arranged in the housing 3 upstream of the electric heating device 13. These second openings 31 are distinct from the first opening 29.

In addition, the second openings 31 in this example respectively have an air passage cross section that is smaller than the air passage cross section of the first opening 29.

According to one advantageous embodiment, the homogenization grating 14 additionally comprises at least one solid part 33 adjacent to the first opening(s) 29.

According to a preferred embodiment, the homogenization grating 14 comprises a solid part 33 adjacent to the first opening 29.

The solid part 33 is positioned between the first opening 29 and the plurality of second openings 31.

According to the example illustrated in FIG. 4, the solid part 33 extends over the entire height of the homogenization grating 14 and over a width that is in, for example, a ratio of the order of one to three with the width of the first opening 29.

Finally, the plurality of second openings 31 or mesh holes form an array which extends over the rest of the homogenization grating 14 from the side of the solid part 33 opposite to the side adjacent to the first opening 29. The second openings 31 are intended to be positioned facing the heating elements 15 of the electric heating device 13 once the homogenization grating 14 is in position in the housing 3 of the heater unit 1 as illustrated in FIG. 2.

The homogenization grating 14 is produced here in the form of a plate that has a first zone Z1 of opening for the passage of air for cooling the heat sinks 27 associated with the electronic control unit 25, and a second zone Z2 forming a grid or mesh for the passage of air for an exchange of heat with the heating elements 15 with a homogeneous flow of the flow of air. The first zone Z1 contributes to the cooling of the electronic control unit 25 through the cooling of the heat sinks 27, while the second zone Z2 contributes to homogenizing the flow of the flow of air toward the heating elements 15 of the electric heating device 13.

The shape of the second openings 31 may be chosen freely to suit the requirements. In the example illustrated in FIG. 4, the second openings 31 are of substantially rectangular shape. Of course, any other shape, for example a rounded shape, may be chosen as an alternative.

The second openings 31 may have air passage cross sections that are non-homogeneous, and are therefore heterogeneous, in order to suit the application.

Notably, the air passage cross sections may be smaller at the points at which the speed of the flow of air passing through the homogenization grating 14 is higher. The air passage cross section can be reduced by thickening the material around the second opening. The air passage cross sections can be deduced for example from aerodynamic flow simulation(s) results.

The homogenization grating 14 is for example made of plastic. It may notably be made of the same material as the housing of the heater unit 1.

Finally, the homogenization grating comprises fixing means 35 for fixing it to the housing 3 of the heater unit 1.

Thus, the presence of the first opening 29 upstream of the heat sinks 27 allows a proportion of the flow of air to pass toward the heat sinks 27 in order to cool same. The first opening 29 is dimensioned to distribute a minimum flow of air to the heat sinks 27.

The second openings 31 on the other hand allow a homogeneous flow of air to be distributed to the heating elements 15 of the rest of the electric heating device 13. The second openings 31 are able not to be homogeneous and are designed to improve the distribution of the flow of air.

The solid part 33 adjacent to the first opening 29 makes it possible to avoid there being too great a temperature difference between the air outlets of the electric heating device 13 on the side comprising the heat sinks 27 and on the other side which has none of same.

The homogenization grating 14 thus makes it possible to distribute a substantially homogeneous flow of air to the electric heating device 13 while at the same time complying with the imposed constraints of a temperature difference of +/−5° C. and ensuring cooling of the heat sinks 27 so as to cool the electronic control unit 25 specific to the electric heating device 13.

1. A grating for homogenizing a flow of air for a heater unit for a motor vehicle comprising an electric heating device for heating the flow of air, characterized in that it the grating comprises:
a first zone having at least one first opening intended to be positioned upstream of at least one heat sink in the direction in which said flow of air flows, the heat sink being arranged on one side of the electric heating device adjacent to an electronic control unit of the electric heating device to dissipate the heat generated by the electronic control unit, and
a second zone distinct from the first zone and having a plurality of second openings which are intended to be positioned upstream of at least one heating element of the electric heating device in the direction in which said flow of air flows.

2. The homogenization grating as claimed in claim 1, in which said second openings respectively have a cross section for the passage of air that is smaller than the cross section for the passage of air of said at least one first opening.

3. The homogenization grating as claimed in claim 1, having at least one solid part positioned between said at least one first opening and the plurality of second openings.

4. The homogenization grating as claimed in claim 1, having a substantially parallelepipedal overall shape.

5. The homogenization grating as claimed in claim 4, in which said at least one solid part extends over the entire height of the homogenization grating.

6. The homogenization grating as claimed in claim 4, in which said at least one solid part extends over a width that is in a ratio of the order of one to three with the width of the first opening.

7. The homogenization grating as claimed in claim 1, in which the second openings have heterogeneous air-passage cross sections.

8. The homogenization grating as claimed in claim 1, wherein the homogenization grating is made of plastic.

9. A heater unit for a motor vehicle comprising an electric heating device for heating a flow of air bound for the interior of said vehicle, the electric heating device being intended to have the flow of air that is to be heated up passing through it and comprising:
at least one heating element;
an electronic control unit configured to control said at least one heating element; and
at least one heat sink arranged on one side of the electric heating device (13) adjacent to the electronic control unit so as to be able to dissipate the heat generated by the electronic control unit,
wherein the heater unit further comprises a homogenization grating as claimed in claim 1:
positioned in the heater unit upstream of the electric heating device in the direction in which said flow of air flows, and
comprising:
a first zone having at least one first opening positioned upstream of said at least one heat sink, and
a second zone distinct from the first zone and having a plurality of second openings positioned upstream of said at least one heating element in the direction in which said flow of air flows.

10. The heater unit as claimed in claim 9, in which said at least one heating element is a positive temperature coefficient resistive element.

11. The heater unit as claimed in claim 9, in which the homogenization grating is substantially parallelepipedal and said at least one first opening of the homogenization grating extends over a height of the order of 50% to 120% of the height of said at least one heat sink of the electric heating device.

12. The heater unit as claimed in claim 9, in which the homogenization grating is substantially parallelepipedal and said at least one first opening extends over a width substantially equal to the width of said at least one heat sink of the electric heating device.

13. The heater unit as claimed in claim 9, in which the electric heating device comprises a connector bearing the electronic control unit made of a thermally conducting metallic material and in which said at least one heat sink is made as one with the connector.

14. The heater unit as claimed in claim 9, comprising a plurality of heat sinks defining a substantially comb-like overall shape.

15. The heater unit as claimed in claim 9, in which the electric heating device comprises at least one heat exchange fin positioned in thermal contact with said at least one heating element and configured to have passing through it the flow of air that passes through the electric heating device and to transmit the heat of said at least one heating element to said flow of air.
